(19) United States
(12) Patent Application Publication
(10) Pub. No.: US 2025/0275879 A1
(43) Pub. Date: Sep. 4, 2025

(54) THERAPY DEVICE HAVING A QUICK-CHANGE ADAPTER AND QUICK-CHANGE ADAPTER

(71) Applicant: medica Medizintechnik GmbH, Hochdorf (DE)

(72) Inventors: Otto HOEBEL, Hochdorf (DE); Reinhold JOOS, Bad Wurzach (DE)

(73) Assignee: medica Medizintechnik GmbH, Hochdorf (DE)

(21) Appl. No.: 19/108,813

(22) PCT Filed: Sep. 1, 2022
(86) PCT No.: PCT/EP2022/074269

§ 371 Date: May 8, 2025

(51) Int. Cl. A61H 1/02

(52) U.S. Cl. CPC A61H 1/0214; A61H 2201/0107; A61H 2201/1635; A61H 2201/164

(57) ABSTRACT

A therapy device, and a quick-change adapter for same, has an actuator mounted in a frame and having at least one axially projecting shaft and an extremity connection unit which can be coupled to the actuator by the shaft. An adapter piece with an annular disc, in which a fixing element is formed at least over a part of its circumference, is associated with the shaft for the realization of a quick-change adapter, and a fastener has a ring having an annular opening, the width of which is adapted to the diameter of the annular disk, on the inside of which a counter element corresponding to the fixing element is formed and at one free end of which a clamping lever is arranged, which can be adjusted between a clamping position fixing the fastener to the adapter piece and a release position releasing the fastener.

The invention relates to a therapy device with an actuator mounted in a frame and having at least one axially projecting shaft and an extremity connection unit which can be coupled to the actuator by the shaft, wherein the shaft is assigned an adapter piece with an annular disc in which a fixing element is formed over at least part of its circumference in order to realize a quick-change adapter, and in that a fastener is provided with a ring having an annular opening, the width of which is adapted to the diameter of the annular disk, on the inside of which a counter element corresponding to the fixing element is formed and at one free end of which a clamping lever is arranged, which can be adjusted between a clamping position fixing the lock to the adapter piece and a release position releasing the fastener. The invention also relates to a quick-change adapter.

A therapy device with the features of the preamble of claim 1 is known from obvious prior use of the applicant and the IR design DM/097 391, which has proven itself well in practice. In this device, a plug-in system is used to attach footrests or armrests to the actuator, which requires attachment in the axial direction.

It is the object of the present invention to provide a therapy device in which the space required for mounting the extremity connection unit is reduced and this mounting can be carried out quickly and without tools.

This object is solved by a therapy device with the features of claim 1 and by a quick-change adapter with the features of claim 11. Advantageous embodiments with useful further embodiments of the invention are given in the dependent claims.

The above-mentioned therapy device is characterized by the use of a quick-change adapter that allows the limb connection unit to be connected to the actuator in a radial direction, i.e. the limb connection unit can be pushed onto the axle laterally without having to provide additional free space in its axial direction. The adjustment of the clamping lever is sufficient for fixing and can be carried out quickly without tools. The formation of a positive fit through the interaction of the fixing element with the counter element is also particularly advantageous, providing axial locking and thus eliminating an interfering degree of freedom when positioning the limb connection unit.

In this context, it is particularly preferable if one of the parts of the fixing element and the counter element is designed as a nut and the other part as an annular collar, as this provides a positive fit that reliably prevents axial displacement. The cross-section of the nut can be V-shaped and the ring collar trapezoidal.

It is preferable if the nut is arranged centrally on the ring washer and the ring collar is formed on the ring, as this simplifies assembly, especially as the V-shaped nut acts as an inlet bevel. This also further reduces the play and improves axial locking. It is also advantageous that the groove is arranged centrally on the ring washer, which is thus symmetrical with sufficient wall thickness of the groove walls on both sides of the groove.

The fact that the clamping lever has a cam whose cross-section is adapted to the nut and which extends into the nut in the clamping position also serves to improve the fastening of the lock on the annular disk, as this allows the annular disk to be gripped further in the circumferential direction.

It is particularly preferable if the clamping lever is acted upon by the force of a spring that secures the clamping position. In this embodiment, the fastener can simply be placed radially on the ring disk of the adapter piece, on which the fastener is then self-locking and permanently secured until a change is actively initiated by a user against the force of the spring.

It should be noted that the ring opening is dimensioned in such a way that the ring disk together with the clamping lever in the clamping position grips the adapter piece over an arc of more than 180°, i.e. the clamping lever in particular also provides a positive fit that improves the positional stability of the fastener on the ring disk without relying solely on a clamping force or clamping force.

In practice, it has proven successful if the axle can be detachably fixed in an axle holder of the actuator, i.e. the axle can be easily changed to adapt to the limb connection unit or to vary the axial extension of the axle.

The axle also expediently has a thread intended to interact with a threaded receptacle of the adapter piece.

For effective training or therapy, the axle, the limb connection unit and the quick-change adapter are provided in duplicate and the limb connection unit is selected from a group comprising a pedal, a footrest, an armrest and a handle.

The quick-change adapter defined above has a radial bearing on its adapter piece to enable rotation.

The features and combinations of features mentioned above in the description as well as the features and combinations of features mentioned below in the figure description and/or shown alone in the figure can be used not only in the combination indicated in each case, but also in other combinations or on their own, without going beyond the scope of the invention. Thus, embodiments which are not explicitly shown or explained in the figure, but which emerge from the explained embodiments and can be produced by separate combinations of features, are also to be regarded as comprised and disclosed by the invention.

Further advantages, features and details of the invention can be seen from the claims, the following description of preferred embodiments, and from the drawing. It shows:

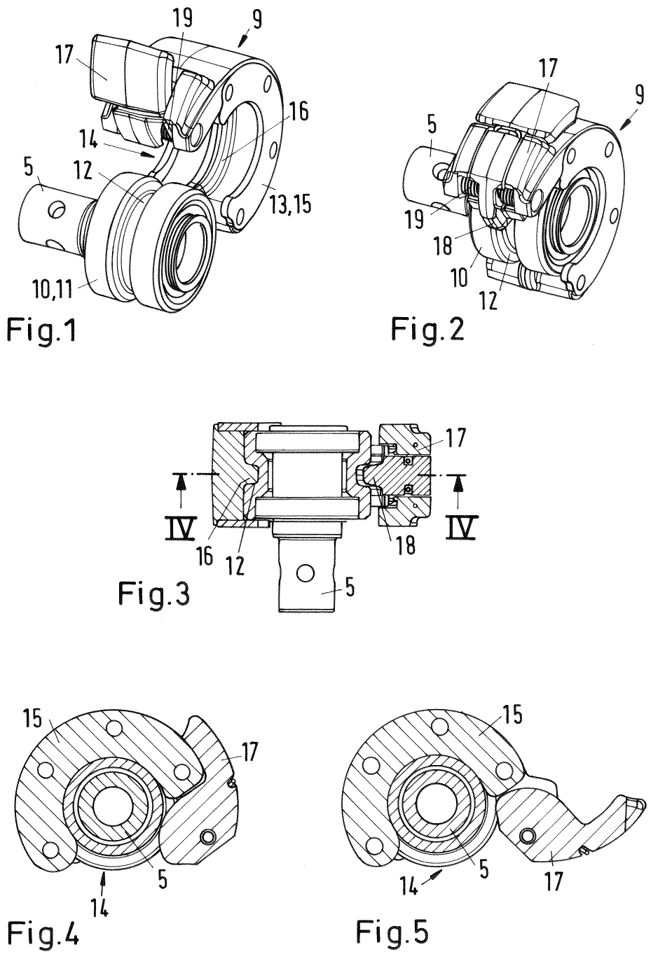

FIG. 1 a perspective view of the quick-change adapter with the fastener separated from the adapter piece,

FIG. 2 a view corresponding to FIG. 1 in the coupled state of the adapter piece and the closure,

FIG. 3 a top view of the object of FIG. 2, shown partially cut,

FIG. 4 section IV-IV from FIG. 3,

FIG. 5 an illustration corresponding to FIG. 4 in the unlocked state of the lock,

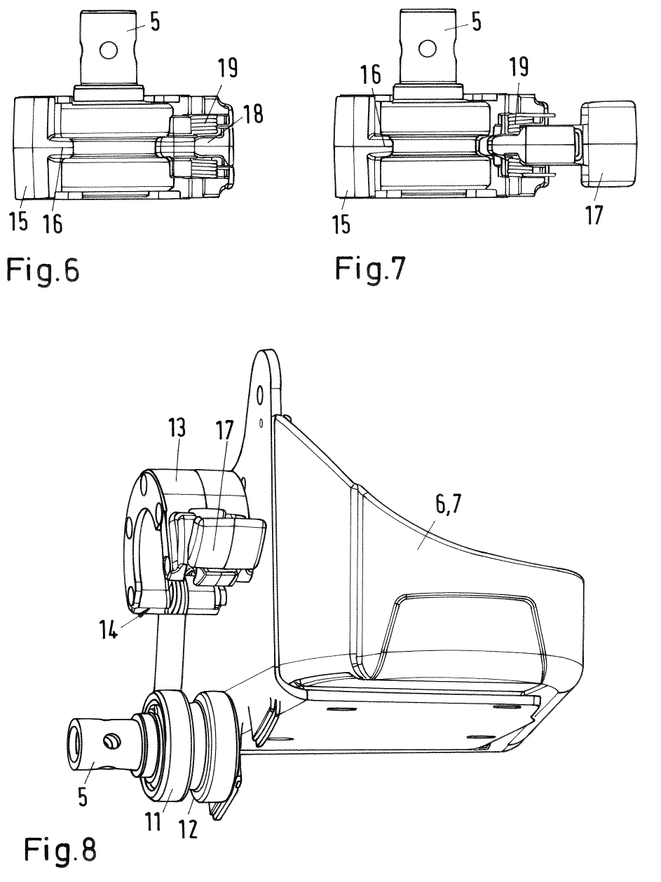

FIG. 6 a view from below of the object shown in FIG. 2,

FIG. 7 a view corresponding to FIG. 6 in the unlocked state of the lock,

FIG. 8 a perspective view of a foot rest as an extremity connection unit with the associated closure, before connection to the adapter piece,

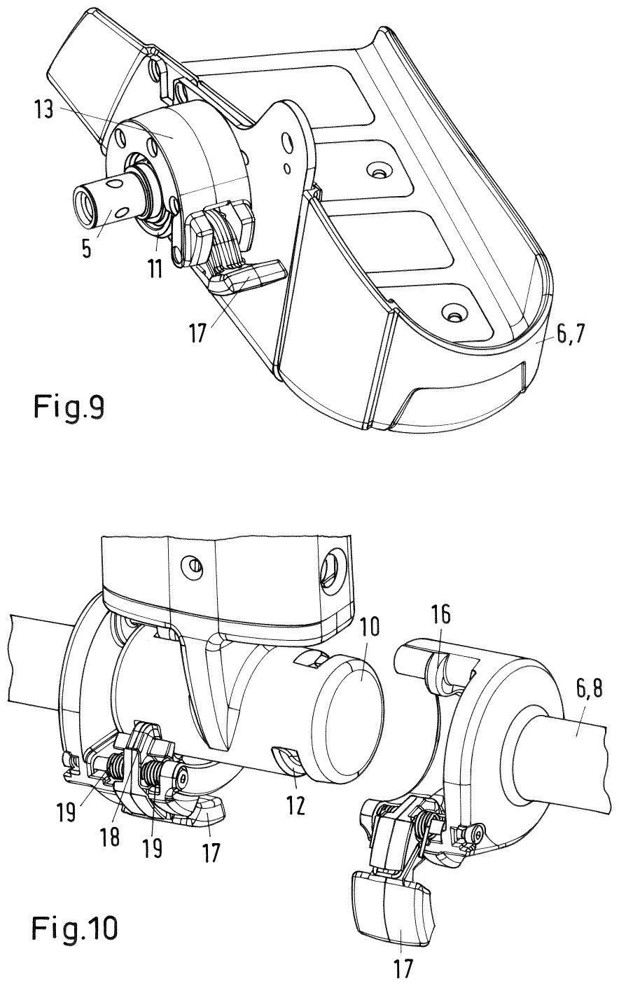

FIG. 9 a perspective view of the object from FIG. 8 after coupling,

FIG. 10 a partial perspective view of two handles as an extremity connection unit with the associated fastener, shown on the left in the coupled state and on the right before coupling,

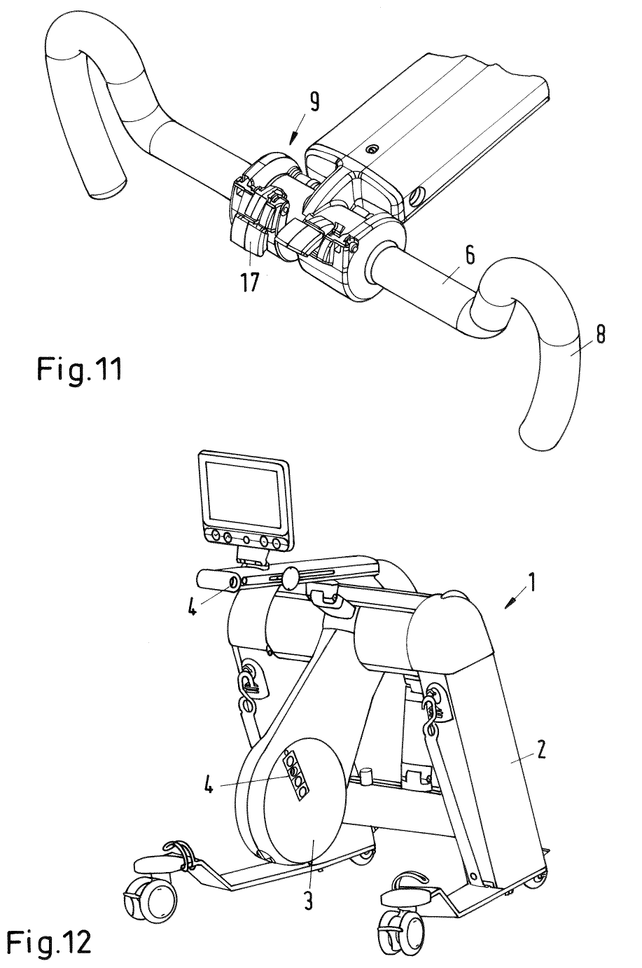

FIG. 11 a perspective view of the object of FIG. 10 as part of a therapy device, shown on the left in the coupled state and on the right before the locking mechanism for coupling, and

FIG. 12 a perspective view of a therapy device with the holder for the axis of the adapter piece in an actuator.

FIG. 12 shows a therapy device 1 with an actuator 3 mounted in a frame 2, in which axis holders 4 are formed on both sides, in each of which an axis 5 not shown in FIG. 12 can be accommodated.

An extremity connection unit 6, which can be coupled to the actuator 3 by the axis 5, is arranged on each of these axes 5, whereby reference can be made to a pedal, a footrest 7 (FIG. 9), an armrest or a handle 8 (FIG. 11) as an example of an extremity connection unit 6.

For the realization of a quick-change adapter 9 shown in FIG. 1, an adapter piece 10 with an annular disc 11 is assigned to the axle 5, in which a nut 12 is formed as a fixing element over at least part of its circumference in the embodiment example shown. FIG. 3 shows that the nut 12 has a V-shaped cross-section and is arranged centrally on the annular disc 11. The axle 5 has a thread intended to interact with a threaded receptacle of the adapter piece 10 and the adapter piece 10 has a radial bearing.

Part of the quick-change adapter 9 is also a fastener 13 with a ring 15 having a ring opening 14, the width of which is adapted to the diameter of the ring washer 11, on the inside of which a ring collar 16 corresponding in cross-section to the nut 12 is formed as a counter element to the fixing element. A clamping lever 17 is arranged at the free end of the ring 15, which can be adjusted between a clamping position fixing the fastener 13 to the adapter piece 10, which is shown in FIG. 2, and a releasing position releasing the fastener 13, which is shown in FIG. 1. Furthermore, the clamping lever 17 has a cam 18 whose cross-section is adapted to the nut 12 and which extends into the nut 12 in the clamping position. The ring opening 14 is dimensioned in such a way that the ring washer 11 together with the clamping lever 17 grips the adapter piece 10 over an arc of more than 180° in the clamping position. FIGS. 6 and 7 in particular show that the clamping lever 17 is acted upon by the force of a spring 19 that secures the clamping position.

For the sake of completeness, it should be noted that the assignment of the nut 12 and the ring collar 16 can also be inverted, i.e. the ring collar 16 can be assigned to the ring washer 11 and the nut 12 to the ring 15.

For training or therapy of both extremities, i.e. both legs or both arms, the axle 5, the extremity connection unit 6 and the quick-change adapter 9 are provided in duplicate.

If there is now an axle 5 inserted into the axle holder 4 on both sides of the actuator 3, to which the adapter piece 10 is attached via the threaded connection, then the extremity connection unit 6, for example the foot rest 7 from FIG. 9, can be assigned to the actuator 3 simply by radially attaching the lock 13, whereby the clamping lever 17 is automatically secured by the pretension of the spring 19. To remove the foot rest 7 again, for example because a patient wants to use the therapy device to train their upper extremities and an arm rest is to be attached, all that is required is to open the clamping lever 17 against the force of the spring 19 and pull off the lock 13 radially without the need for tools and without taking up much space.

### REFERENCE LIST

1 Therapy device
2 Frame
3 Actuator
4 Axis mount
5 Axis
6 Limb connection unit
7 Foot rest
8 Handle
9 Quick-change adapter
10 Adapter piece
11 Ring disk
12 Nut
13 Fastener
14 Ring opening
15 Ring
16 Ring collar
17 Clamping lever
18 Cams
19 Spring

1. A therapy device (1) having an actuator (3) which is mounted in a frame (2) and has at least one axially projecting shaft (5) and a extremity connection unit (6) which can be coupled to the actuator (3) by the shaft (5), wherein the shaft (5) is assigned an adapter piece (10) with an annular disc (11) in which a fixing element is formed over at least part of its circumference in order to implement a quick-change adapter (9), and wherein a fastener (13) is provided with a ring (15) having an annular opening (14), the width of which is adapted to the diameter of the annular disk (11), on the inside of which a counter element corresponding to the fixing element is formed and at one free end of which a clamping lever (17) is arranged, which can be adjusted between a clamping position fixing the fastener (13) to the adapter piece (10) and a release position releasing the fastener (13).

2. The therapy device (1) according to claim 1, wherein one of the parts of the fixing element and the counter element is designed as a nut (12) and the other part is designed as an annular collar (16).

3. The therapy device (1) according to claim 2, wherein the nut (12) is V-shaped in cross-section and the annular collar (16) is trapezoidal in shape.

4. The therapy device (1) according to claim 3, wherein the nut (12) is arranged centrally on the annular disc (11) and the annular collar (16) is formed on the ring (15).

5. The therapy device (1) according to claim 4, wherein the clamping lever (17) has a cam (18) which is adapted in cross-section to the nut (12) and extends into the nut (12) in the clamping position.

6. The therapy device (1) according to claim 1, wherein the clamping lever (17) is acted upon by the force of a spring (19) securing the clamping position.

7. The therapy device (1) according to claim 1, wherein the ring opening (14) is dimensioned such that the ring disc (11) together with the clamping lever (17) in the clamping position engages around the adapter piece (10) over an arc of more than 180°.

8. The therapy device (1) according to claim 1, wherein the axis (5) can be detachably fixed in an axis holder (4) of the actuator (2).

9. The therapy device (1) according to claim 1, wherein the axle (5) has a thread intended for cooperation with a threaded receptacle of the adapter piece (10).

10. The therapy device (1) according to claim 1, wherein the axle (5), the extremity connection unit (6) and the quick-change adapter (9) are provided in duplicate.

11. The therapy device (1) according to claim 1, wherein the limb connection unit (6) is selected from a group comprising a pedal, a footrest (7), an armrest, a handle (8).

12. A quick-change adapter (9) for a therapy device (1), wherein an adapter piece (10) is provided with an annular disc (11) in which a fixing element is formed over at least part of its circumference, and wherein a fastener (13) is provided with a ring (15) having an annular opening (14), the width of which is adapted to the diameter of the annular disc (11), ring (15) is provided, on the inside of which a threaded element corresponding in cross-section to the fixing element is formed and at one free end of which a clamping lever (17) is arranged, which can be adjusted between a position fixing the closure (13) to the adapter piece (10) and a position releasing the fastener (13).

13. The quick-change adapter (9) according to claim 12, wherein the adapter piece (10) has a radial bearing.
